(19) United States
(12) Patent Application Publication
(10) Pub. No.: US 2014/0199670 A1
(43) Pub. Date: Jul. 17, 2014

(54) Multimodal cognitive performance benchmarking and Testing

(71) Applicant: Sync-Think, Inc., Boston, MA (US)

(72) Inventor: Matthew E. Stack, Boston, MA (US)

(73) Assignee: Sync-Think, Inc., Boston, MA (US)

(21) Appl. No.: 13/694,873

(22) Filed: Jan. 14, 2013

(51) Int. Cl. G09B 23/28

(52) U.S. Cl. CPC G09B 23/28
USPC 434/236

(57) ABSTRACT

Multimodal cognitive performance testing identifies a benchmark test administered at the beginning and the end of a battery of tests in which cognitive resource changes are detected and are used to correct additional tests sandwiched between the benchmark tests. A test sequence methodology is described for deriving a minimum number of the additional tests and for ordering the additional tests based on multimodal test variables and correlation of a test with a predetermined cognitive function.

### FIELD OF THE INVENTION

This invention relates to multimodal cognitive performance testing and more particularly to the use of strategic benchmarking to determine performance change when administering a battery of tests.

### BACKGROUND OF THE INVENTION

As will be appreciated in evaluating cognitive performance, a diverse array of tests has been utilized to diagnose cognitive disorders. Often times these tests are administered as a sequential test in a battery of tests. This battery of tests can include various cognitive tests such as surveys, reaction time tests, balance tests, imaging tests such as functional magnetic resonance (fMRI) and CAT scans, opto-cognitive eye movement analysis, mechanical motion tests, biomarker tests, EEG and MEG tests and smooth pursuit testing modalities.

When clinicians seek to diagnose a particular cognitive performance malady or disease it is not uncommon to subject the patient to a battery of tests that can last hours in length. While the use of these tests has been widely reported, there is a problem in the administration of a battery of such tests. When administering a battery of cognitive tests, the patient generally declines in cognitive performance due to fatigue that decreases attention span, test difficulty, physical strenuousness of the tests. As a result, cognitive performance may degrade as the testing procedure is prolonged. The net result of administering a battery of tests is that one cannot adequately quantify the cognitive performance of the test taking individual due simply to the length of the battery of tests itself, to say nothing of the difficulties and cognitive loads involved in the tests.

It is presently and generally recognized that a single cognitive testing modality or test type cannot necessarily isolate a particular cognitive impairment for an individual. Thus, it has been proposed that a suite of different types of tests or different modalities be used that may be more useful in pinpointing and quantifying the cognitive state of the individual.

There is therefore a need to be able to administer a battery of tests and to assure that the tests take into account the change in cognitive ability, increase or decline, as the test subject endures the testing procedures.

Moreover, with the recognition that different types of tests have different cognitive loads and difficulties, there is a necessity to categorize these tests and to be able to select which tests to administer for a given cognitive condition. In the selection process it is also important to be able to minimize the number of relevant tests and therefore the length of the battery of tests. Thus, there is a critical need to be able to select appropriate tests for a particular disease state. It is then important to establish the level of correlation to different cognitive functions for each test so as to be able to select a minimum number of tests that are applicable to the particular disease state, taking into account the effect of the tests on the test taking individual. Having selected tests that have a minimized effect on the individual, there is nonetheless a requirement to quantify the decline of the cognitive performance of the individual during the battery of tests to be able to correct the individual test score results for the measured decline.

It is important to note that as cognitive function declines, in some cases the correlation or predictive power of the test declines. For example, as an illustration of the principle, when evaluating whether a patient has mTBI (mild traumatic brain injury), the patient is first tested to see if he or she can spin around in a circle eight times without falling. If the patient falls, the patient is very likely to have mTBI. After the spinning test, if the patient immediately takes an opto-cognitive test, which in itself is a very accurate mTBI diagnostic test, the opto-cognitive test may be negatively affected as the patient's eyes will be saccading as an aftereffect from the spinning. Thus, the cognitive resource that declined from the previous test reduces the ability for the next test to accurately predict a cognitive function. As a result, when assessing the correlation of a test to a cognitive function of the brain or a neurological disorder, it is important to take into consideration how the correlation of the test to the disorder changes dependent on the cognitive resource depletion.

Thus, while in the past batteries of tests have been administered their accuracy has not heretofore taken into account the decline of the individual as the test proceeds. Secondly, there has been no recognition that a cognitive decline problem exists. Further, there is no standardized rating or method that enables one to compare the results of one modality or type of test with another modality or type of test.

The net result over the past thirty years is that while a significant amount of testing has occurred, no reliable and quantifiable results have been achieved when a battery of tests has been administered.

By way of further background, there is an emerging trend towards the use of multiple types or modalities of testing in order to robustly evaluate a patient's cognitive function and cognitive performance.

Multimodal testing as used herein refers to the use of different testing types or testing modes or modalities to converge on a diagnosis.

One of the reasons for the emergence of multimodal testing is that different cognitive testing modalities are used to measure different aspects of cognitive performance. For instance, reaction time is thought to be one modality. Imaging technology tests such as fMRI are thought to be another modality. The application of opto-cognitive eye movement analysis is thought to be another modality, as is balance mechanical motion analysis. Separately EEG and MEG are sometimes compressed into one or sometimes divided into two different modalities.

Thus, it was thought that a number of different testing modalities could be combined for robust diagnosis. At an informatics level, the modalities can be broken into categories based on the type of data collected from each of the functional tests. The types of data include periodic numerical data, imaging data, signal data or continuous streams of data. Each of these can be thought of as snapshots of the brain.

This emergence of multimodal testing is the result of coming to the conclusion that using a single test modality is not accurate enough as a diagnostic tool. In short, a single test modality cannot serve as an effective general-purpose cognitive function test. The use of a single modality to describe cognitive function is perhaps impossible because of the complexity of the brain, the complexity of the circuits within the mind and the difficulty of designing pure play tests to assess multiple different types of functions in the brain. As a result, single mode tests have been thought to assess just one of several major functions of the brain at a time. Therefore, if one wants to capture a fully integrated assessment of a patient's cognitive function or mental circuitry, one must administer a multimodal battery of tests.

Administering a battery of tests means applying one test after another, after another, such that by the time a patient has completed the testing process, he or she may have run through a dozen or two sub-tests, each of the sub-tests typically containing either questionnaire, or an activity, or some type of functional test that assesses a specific part of the cognitive circuitry. Sometimes the tests or modalities are administered in parallel, for instance monitoring EEG while that patient completes a survey.

Applying a battery of tests traces its heritage to the nature in which cognitive testing emerged through surveys. These surveys were designed to interrogate a patient in a specific way, mostly in a narrow way, in order to assess the patient's mental state of being. These surveys would typically be divided into, for instance, various emotional tests, or memory, or recall tests. The tests were not very broad in scope, and as a result, it was thought that applying multiple survey tests in concert or in a battery would make sense.

Designing and applying a battery of single mode tests is different from multimodal cognitive testing. A single mode battery of tests is a series tests, mostly within the same modality, whereas multimodal testing means taking a series of cognitive tests from across the multimodal spectrum. For instance, one can take reaction time tests, cognitive surveys, fMRI imaging, opto-cognitive testing, together to create a design series, and apply these to testing the patient's cognitive function. The result is combining the diagnostic capabilities of the different types of tests or modalities. As another example, multimodal testing could involve one or a series of reaction time tests being applied to the patient in either a single session or split across several sessions that are relatively near to each other chronologically. This type of test could be followed by CAT scans or fMRI tests, followed by an opto-cognitive assessment. All of these tests involve different modalities, and the results would be then bucketed in a patient record and analyzed.

Although a subtle point, it is important to distinguish the fact that multimodality testing implies a relatively short time elapsing in between the tests. For instance, today, if a patient gets an fMRI, and a week later, they receive reaction time testing, and two weeks later, they receive opto-cognitive baselining and testing, at three different labs administered by three different physician groups or practices, or institutions performing this research, this would not be considered multimodal testing. Instead, because of the amount of time elapsed, this would be thought to be much less multimodal testing, and much more about repetitive sessions.

On the other hand, multisession testing involving cognitive performance evaluation and cognitive testing of a single patient is often referred to as portfolio technology approach to measuring cognitive performance or evaluating cognition. The primary difference between multisession or portfolio technology analysis of the patient and multimodal analysis and multimodal testing is that the multimodal testing occurs within a very short testing cycle or timeframe. For instance, for a single battery of multimodal tests, a patient comes into a lab, receives opto-cognitive testing, followed by reaction time testing, followed by fMRI testing, followed by a CAT scan, followed by an EEG and a MEG all in a single elongated time period. The results of all of the multimodal tests are thought to establish a reliable baseline, or a single snapshot, of the patient's cognitive performance at a specific moment in time.

The goal of multimodal testing is to compress the evaluation of the patient from multiple technological angles and multiple diagnostic methods into as short a time frame as possible. Thus the administration of multimodal tests is equivalent to simultaneous evaluations of the patient, and so that the patient's cognitive state is not allowed enough time to significantly change from the start of the testing to the conclusion of testing. This forms something of a snapshot of the patient, and is significant and meaningful as a source of data and information about the patient's mind and cognitive state, allowing one to assume that no cognitive change occurred during the battery of tests.

Multimodal testing is therefore thought to provide an integrated holistic multi-angle, multi-technological evaluation, as close to a simultaneous administration as possible, with the purpose to create an integrated patient record of the cognitive state of a patient.

The above multimodal testing generates a significant amount of information, which is data recorded and logged in a patient record. At a different time, or after a pharmaceutical product has been administered, or before or after a food product has been taken, or a drug has been ingested, another multimodal testing session can be administered to the patient. This results in another batch of data and information that is collected. The results imply multiple technological angles of evaluation of the cognitive state of the patient at two different points in time, with some statistical or significant event having transpired in between those states. This multi-series of integrated informatics collected on the patient's cognitive state provides significant amounts of information that can be data mined in order to discover trends and patterns and differences in the patient's cognitive state that manifest itself across different platform technologies and across different modalities. From this one can infer that there may be statistically significant changes within the patient, and that a change in the cognitive state has been detected.

On the other hand, implicit in the desire to implement and create multimodal cognitive testing is an understanding that perhaps no single modality will truly expose changes that have occurred in the cognitive function or in the state of the mind, the brain, or the neurology of the patient. Multimodal testing sessions taken before and after some time has elapsed, or before and after an event of significance permits a greater statistical resolution in understanding the cognitive state, than a single state.

The application of multimodalities is confirmatory of a cognitive state, with the multimode tests improving the statistical significance of any of the tests taken alone. It also improves its accuracy and reliability, as well as the test/retest significance over time.

Unfortunately, there are significant downfalls and limitations in the current state of the art of administering multimodal testing and data capture and collection.

As discussed previously, the first problem is the decline in cognitive function during the battery of tests. A second problem lies in the fact that different technologies are applied to measuring the cognitive performance and state of the brain, and the mind. As a result, the data collected from each of these platform technologies is very different.

In the imaging case, or in the case of fMRI, CAT scans or other types of imaging technologies, the output is most often maps of metabolic activity or electrochemical activity within the brain as detected by various different technologies. Mostly what is involved is a set of technologies that maps the topology of the brain. The output can be thought of as a multimedia picture or image data. On the other hand, EEG and MEG involve signal waveforms or times series data, where the activity of various sensors is continuously polled over a period of time. EEG and MEG analysis is most often used and analyzed over time as opposed to compression into single state form, although some compressive mechanisms have shown some promise.

Opto-cognitive testing for instance, is typically applied over time with the results compressed to a single score output using a single metric. The same can be said for reaction time tests, which typically involve the administration of multiple reaction time tests. Then a standard deviation averaging or other statistical compression mechanism is applied, to convert the reaction time tests into a single metric.

It stands to reason, at minimum, that the data collected across modalities is collected across different time series, with different resolutions, different granularities, different margins of error and across different degrees of statistical significance. Moreover, the collected data has different tests/retest accuracy guardrails, and different scales of scoring, as well as different ranges of score, different numerical data scoring and different compressive data scoring.

In other words, it is very difficult to align the data extracted from the multimodal platform technologies into a single integrated informatics data format that can be statistically analyzed in order to produce one or two analytic metrics to describe cognitive state.

Furthermore, some modalities simply cannot be administered in parallel, and must be administered sequentially. For instance, it is currently impossible to take an fMRI and a CAT scan at the same time as performing a balance test, where the patient is balancing vertically on his feet, on a chair, or on a rubber ball, or on a platform with accelerometers.

However, some modalities can be administered in parallel. For instance, opto-cognitive testing can be administered in parallel with EEG/MEG testing since the patient can wear an EEG or MEG cap with sensors at the same time their eyes are scanned. Eye scanning can also be conducted at the same time as an imaging test, such as fMRI, is examined. Eye tracking can be taken at the same time that reaction time tests are taken. Moreover, reaction time testing typically requires mechanical motion, and therefore reaction time is difficult to assess at the same time as other types of mechanical tests or balance tests. In academic and institutional research, fMRI and CAT scans are sometimes done at the same time as reaction time tests, or eye tracking, or opto-cognitive tests. Additionally, reaction time tests are sometimes administered at the same time as EEG tests. An EEG or MEG test is often administered at the same time as an opto-cognitive test, typically because of the legacy mechanism in which eye tracking is used to detect blinks. Blink detection can be used to filter out the effects of blinks from the EEG and MEG record and data set. As an aside, this is because when a patient blinks his eyes, this generates a significant amount of noise in the EEG and MEG signal, which can sometimes be viewed as a sharp spike in the data or the time series output of the sensors. In the past, this data was typically ignored. However, with the ability to detect blinks, this data provides valuable information when paired with an opto-cognitive test.

Suffice it to say, because only some of these platforms and modalities can be administered in parallel, the majority of multimodal testing is administered sequentially.

The application of multimodal testing in series, presents a number of challenges, not the least of which is cognitive decline during the series of tests.

Cognitive tests tend to take time. Imaging tests such as fMRI can sometimes take half an hour to an hour to configure before the test can be actually administered. Opto-cognitive testing, although relatively quick, still requires some setup on the order of minutes and sometimes seconds. Such setup and configuration time must also be factored into multimodal testing, and thought of as transaction costs, or lags, in between the various modalities. There is also additional lag time for transitioning the patient from one modality test to another. Moving a patient from one modality to the next costs time and can also introduce discomfort for the patient such as headaches and boredom. In some cases, annoyance at the amount of time that has elapsed too can affect the patient's state of mind and change the patient's baseline state of cognition.

As a result, at the beginning of the test while the patient may be optimistic, at the end of the testing paradigm the patient may be slightly annoyed, discomforted and looking for something else to do. Also, the patient can grow exhausted or tired over the course of the administration of multimodal cognitive testing. The patient can grow tired of receiving different types of instruction, or there can be a test/retest bias, or a learning effect, introduced over time. For instance, reaction time tests may require a tutorial. At first, the reaction time test paradigm or modality may be somewhat novel to the patient, but as the patient grows more experienced at taking the tests, the patient may be seen as scoring better than the patient's score at the beginning of the reaction time tests. This seeming increase in cognitive ability constitutes a cognitive functional change as the patient learns as much as any “learning effect” that is unaffiliated or disassociated with any measure of cognitive function.

Currently, patients can be tied up for six hours or more of nonstop sequential testing. This amount of time is simply unacceptable for a data and informatics perspective, and every effort should be made to develop a minimum set of relevant tests.

Furthermore, tests can be thought of as having variability in terms of cognitive load. Some tests are easier to take, and some tests are harder to take. Some require more intent or more will to conduct. Tests like reaction time tests, mechanical tests or balance tests can introduce fatigue and can be more strenuous physically, so the muscles may fatigue before the will or the brain fatigues. Similarly, test difficulty is not uniform across the tests. For instance, when taking reaction time tests, or possibly even the opto-cognitive tests, the difficulty of the tests may vary, even within the modalities. Difficulty is defined here as how involved and focused a patient must be during the test.

Given all of the above factors that result in cognitive decline during test taking, the field is currently absent of a theory of how to arrange, order or design a sequence of these tests. Strenuousness, cognitive load, difficulty, training effect and learning effect, are each different variables that must be thought of across the paradigm or across the modalities as the tests are administered. Currently, there is no evidence to show or suggest a theory of how to sequence these tests in a meaningful way.

Today, each modality contains, within itself, a series of custom-designed analytics, designed to filter signal from noise within the data, and designed to narrow, filter, extract and identify only a single feature of analysis out of a multi-featured data file or data source. This filtering or signal processing is typically tailored to each modality in order to extract some relevant piece of information. However, the pieces of information extracted from each of the modalities are not necessarily an aggregate testing the same thing.

For instance, applying multimodal cognitive testing to the process of analyzing the side effects or outcomes of Alzheimer's disease, Parkinson's disease, mTBI or dementia is more challenging than it may seem at first glance. Taking a reaction time test designed to determine color blindness, for instance, by asking a patient to press the spacebar as quickly as possible if the triangle they see is red or green in color, is a test specifically designed to capture the millisecond-reaction time delay in the decision required by the patient to assess the color of the objects or icons presented on-screen. This is a color blindness test, specifically optimized to determine and score on a quantitative level across a range of outcomes and results in a color blindness score. This will be termed Test A.

As for Test B, an opto-cognitive test is designed to evaluate the effects of mild traumatic brain injury on the psychotic tendencies of the eyes moving across a smooth pursuit eye movement paradigm. Test B involves testing the variability or regularity of the patient's ability to follow an on-screen dot or icon. It also may involve standard deviation of the eye's ability to track an icon moving in a smooth curvilinear manner across a screen or in front of the eyes of the patient. This test involves the calibration of the K and global variables down the algebraic manipulations of the standard deviation, as well as the weights and mean squares or sum of squares error, or for that matter weights or counter balances within the algebraic expressions. All of the above have been tailored specifically to the quantification, or the normalization, of the opto-cognitive test scores. The result is that scores within a certain range can be indicative of mild traumatic brain injury, while scores on the other end of the scale, or at a different range of the scale, may be indicative of normal state of cognitive function.

As to Test C, the density of metabolic activity within the brain is measured by an fMRI test. This test produces image data which is then filtered with a set of Gaussian for example filters and convolutions in order to extract edge detection regions of activity in the brain that match a certain metabolic level associated with intentional activity or cognitive activity. When activated by any given stimuli this results in brain regions with a density function to show the number of pixels or the percentage of pixels of the image of the brain. Moreover, a slice image of the brain may be analyzed.

Thus, Test A is a quantitative score indicating whether the patient is colorblind or not, and can be a percentage probability score or Boolean value, or simply can be a true or false indication for a given color. The opto-cognitive output Test B is a score for instance from 1 to 10, where 1-2 is indicative of decreasing cognitive function associated with mTBI, where greater than two is normal. Finally, the fMRI Test C is associated with imaging, and the output is a set of pixels forming a bitmap, as well as a percentage score of the percentage of metabolic area in different regions of the brain.

Framed in an informatics manner, Test A's result is a Boolean, Test B's result is a floating point and Test C's result is an array or table. A Boolean, a float and array cannot be compressed into a single-weighted metric unless each score or each modality is by itself converted into a single normalized assessment value. Thus, some normalization function must be applied to each of the modalities in order to make them compatible analytically.

As can be seen, providing a diagnosis utilizing multimodal testing is difficult, if not impossible, today because it is difficult to capture in a single informatics record the results of a battery of multimodal tests. This is because of the inconsistencies at the data layer. Instead, informatics today can be thought of as a categorization system, or a hierarchical system, whereby records of data are stored for each of the modalities, and each of the corresponding data files is simply compressed into a single folder for the purposes of tagging them to a single session in which all the modalities were applied. For instance, today one might see these results captured on a patient on the date of the battery of tests. The above level of granularity reflects a practical limitation in terms of the amount of time and transaction costs, the switching costs and the learning costs of applying multiple modalities. More importantly it reflects a fundamental challenge of aggregating the scores across multiple modalities in some grand unifying, meaningful way. In the absence of that, currently the clinician simply compresses the results into one folder, and puts off analysis to a later date.

In summary, a deep and fundamental problem in multimodal cognitive testing today is that the testing paradigm takes so long to administer that it is absolutely impossible to administer the test in any reasonable fashion that does not involve some fundamental shift in the state of mind of the patient taking the test. Whether exhaustion, the duration of testing, the complexity of the testing or training effects, there is some significant probability that in multimodal testing the patient's cognitive function will change. For instance, the patient may not have eaten or will have endured a sufficient number of high cognitive load tests that they will be cognitively exhausted. Moreover, during the battery of tests there may be a depleted glucose supply readily available for cognitive activity. Some other form of readily available energy source for the brain will have been depleted, preventing the brain from operating at a high capacity. Additionally, it is possible for the cognitive function to improve during testing. For instance, in the administration of reaction time tests, balance tests and surveys, it is entirely possible that the results of the survey or the reaction time tests will also exhibit significant learning effects over the course of the multimodal cognitive testing, especially when multiple tests are administered that are similar in nature.

In summary, a mechanism is currently missing in the field to account for the change in cognitive function during a battery of tests.

### SUMMARY OF INVENTION

In order to address fatigue and cognitive change during a battery of tests, a benchmark test is administered at the beginning and end of the battery of tests and cognitive performance decline is detected. This decline is then used to adjust the results of the battery of tests to account for the decline in performance so as to provide normalized results that are then used in diagnosis.

As part of the subject invention, a system is provided for rating each of the tests as to cognitive load, test difficulty and correlation to a specific cognitive function. This rating is then used to establish the best benchmark test for a given patient's condition to measure the patient's cognitive performance. As a benchmark, this test is given at the beginning and at the end of the battery of tests, with additional tests sandwiched there between.

After selection of a benchmark test, a minimum number of additional tests are selected. These additional tests are sandwiched between the benchmark tests and are selected based on the above ratings as well as the quality and relevance of a test for a particular cognitive function of the brain. This minimum set of tests is selected to provide highest relevance and best cognitive testing results, with the minimum set and benchmark used to diagnose a suspected neurological disease or cognitive function abnormality.

During the administration of the battery of tests, determinations are made in real time as to patient performance and if a particular test is not yielding either good or statistically significant results, a test that tests for the same cognitive function abnormality or disease is substituted. Additional tests that evaluate the same cognitive function abnormality or disease can also be added onto the list of tests. The result is a battery of tests that yield the most clinically significant results while minimizing the overall test administration time.

Note that the above test procedure can be conducted using a specialized processor in the form of a module for measuring change of cognitive performance, for correcting test scores and for ranking and selecting tests to be administered in a battery of tests.

More particularly, this invention describes a strategic system to address the problem of patient fatigue and cognitive deterioration during the administering of a battery of tests to quantitatively assess the patient's cognitive performance through the use of multiple cognitive tests, each of a different type or modality. The multimodal testing involves several steps to come to the diagnosis of the patient's cognitive function and behavior.

The first step of the invention is ranking the multiple modalities being used for cognitive performance testing. This ranking process involves populating a matrix of all the cognitive test modalities with their characteristics. The three characteristic categories ranking is derived from a matrix that take into account the cognitive load associated with a particular type of test, how difficult it is to take the test and the level of correlation the test has to different cognitive functions of the brain.

The cognitive load of the test modality is defined as how mentally taxing it is to take the test for the patient. The category of how difficult the cognitive testing modality takes into account how difficult the test is to administer, how difficult it is for the patient to learn how to take the test and how strenuous it is physically on the patient to take the test. The correlation of the test to a particular cognitive function is the predictive power it has to be able to accurately evaluate a cognitive function of the brain.

The second step after quantitatively indexing or ranking these various characteristics of all the cognitive testing modalities is to determine the sequence of cognitive testing modalities using this information. That is, from this matrix, one can derive the minimal list of cognitive testing modalities necessary to come to an accurate diagnosis. Dependent on whether the purpose of the cognitive testing was to evaluate the patient's performance for a specific cognitive function or to diagnose the patient regarding a particular cognitive disorder or disease, the minimal list of modalities of cognitive testing modalities will be different. The minimal list is important so that the results of the tests will be valid and not unduly influenced by fatigue or cognitive function changes.

Then from this list, a benchmark test must be chosen. This benchmark test will be administered once at the beginning of the sequence of tests and again at the end of the sequence. This benchmark test is very important to properly measure changes in cognitive function during the battery of tests. As mentioned above, the cognitive function of a patient changes as the patient goes through the battery of tests due to many factors such as fatigue, mental and physical, and loss of motivation.

The benchmark test must be of low cognitive load and have high correlation to what cognitive function is tested for. Unlike the battery of tests today that assume the cognitive state of the patient is the same for each test from beginning to the end of the session, the subject benchmark test allows for one to determine the change the patient's cognitive state undergoes from beginning to the end of the battery of tests. The benchmark test is chosen as the one that is more accurate and realistic for a particular cognitive function given the fact that the patient is likely to deplete cognitively with each test. For example, after hours and hours of testing, the level of attention the patient has to take a test that is towards the end of the sequence might be a lot more reduced than the first test in the sequence. By being able to quantify the difference from start to finish of the battery of tests, the rate of cognitive depletion associated with the battery of tests for that patient can be determined. With this information, the patient's data from the battery of tests can be reassessed relative to measured cognitive change.

The remaining tests on the minimal list of cognitive testing modalities are then arranged in an order that takes into account these tests' cognitive load, the level of correlation the test has to assessing a specific function of the brain and which function or functions of the brain it tests for.

It should be mentioned that with the appropriate computing power, the output of each cognitive test is analyzed while the patient is taking the battery of tests. In other words, as soon as the patient has taken a cognitive test on the list, the output is analyzed while other cognitive tests down the sequence of tests are being performed on the patient.

By doing so, the test administrator or a computing device administering the tests can determine on the spot during that testing session which cognitive tests should be either substituted or added to the list of tests. The cognitive tests to be added onto the list of tests may be a repeat of tests already on the list to arrive at statistically significant result. Alternatively, new tests may be added to further test a specific cognitive function of the brain for more information. It should be noted that these additional cognitive tests should be added on at the end of the sequence but before the last test, the benchmark test, in order for the benchmark test to serve its purpose to baseline the cognitive depletion or improvement of the patient during the battery of tests.

The next step of the multimodal testing is data and score output collection and analysis. A categorical method of storing data that includes adjoining bulk data into a folder per modality has been described in the prior art. However for this invention, in addition to this bulk data storage method, the quantitative index or ranking of the variables mentioned previously, such as cognitive load, is stored alongside the output score. For multimodal testing, the use of a quantitative index of variables is crucial because there needs to be a way to compare the various scores and data when using different types of tests. The quantitative indexes can be then utilized to determine a quantitative numerical outcome, such as a weighted index score, for every modality. This allows for statistical analysis to be possible for modalities that do not provide quantitative data type outputs and to be able to determine the probability that the resulting score is diagnostically significant or relevant. Such statistical analysis may include a standard deviation computation, where one could position the output on a normal distribution of normalcy to establish a statistically relevant number for possible statistical inference analysis. Furthermore, this process amounts to what may be considered the development of an indexing system, where the indexing system converts each of the multimodality testing scores into a relatively straightforward, easily translatable score from one modality to the next. Thus, the resulting score in some numerical form, such as a fraction or a percentage, allows the physician, clinician or even a computing device with an algorithm, to compare each modality's results side by side in the same data format.

In addition to the cognitive performance and function diagnostic improvement benefits, the invention provides an emotional benefit for the patient since the subject system can provide an immediate diagnostic outcome. The invention permits instantaneous feedback on the patient's score, thus minimizing the amount of time the patient and the caregiver have to wait before the scoring session produces meaningful input. Faster results mean faster determination of course of action that could greatly benefit the patient from a treatment standpoint as well, allowing less time for possible mental anguish for the patient waiting on a diagnosis.

This invention proposes that multimodal testing is still dependent on the type of cognitive function one is evaluating, or the expected outcome of the cognitive function one might seek to validate. It is not the intent of multimodal testing to administer all known cognitive tests, but rather to design multimodal testing, for instance, to test for neurological disorders in an informed and strategic manner. Thus, the multimodalities are applied to maximize the validity of the data collected, while minimizing the amount of time taken to assess it, and to do so in a way that is clinically relevant.

In summary, multimodal cognitive performance testing identifies a benchmark test administered at the beginning and the end of a battery of tests in which cognitive resource changes are detected and are used to correct additional tests sandwiched between the benchmark tests. A test sequence methodology is described for deriving a minimum number of the additional tests and for ordering the additional tests based on multimodal test variables and correlation of a test with a predetermined cognitive function.

### BRIEF DESCRIPTION OF THE DRAWINGS

These and other features of the subject will be better understood in connection with the detailed description in conjunction with the drawings of which:

FIG. 1 is a diagrammatic illustration of the testing of an individual for cognitive performance utilizing multiple test modalities, also indicating that additional tests are sandwiched between initial and final administrations of a benchmark test that will detect any change in cognitive performance resulting from the administration of the battery of tests, with that change, if detected, used to adjust the test results;

FIG. 2 is a flowchart for multimodal testing indicating ranking of the tests, the forming of a sequence of tests for the battery of tests and the adjustment of the test results in accordance with detected cognitive changes;

FIG. 3 is a matrix illustrating cognitive performance test modality variables correlated with the cognitive function tested for;

FIG. 4 is a graph showing the rate of change in cognitive resource over time, or ΔCR/t, illustrating the average cognitive resource change over the administration of battery of tests;

FIG. 5 is a diagrammatic illustration showing the score offset index for a series of tests T₁, T₂, T₃, T₄, T₅ and T₆ in which ΔCR is measured for each of the tests, with the adjusted score reflected by the movement of the original intersection between the test score and a standard distribution curve for the test due to the score offset;

FIG. 6 are the formulas used for calculating the adjustments of the individual test scores as a result of detected change in cognitive function or resource during the administration of the battery of tests;

FIG. 7 is a chart useful in determining the order of testing for a battery of tests showing a mix of weighing four different variables;

FIG. 8 is a graph of Cognitive Resource Decline over time associated with a series of tests used to determine mTBI; and,

FIG. 9 is a flowchart indicating mTBI Test Variable Analysis performed by the subject invention.

### DETAILED DESCRIPTION

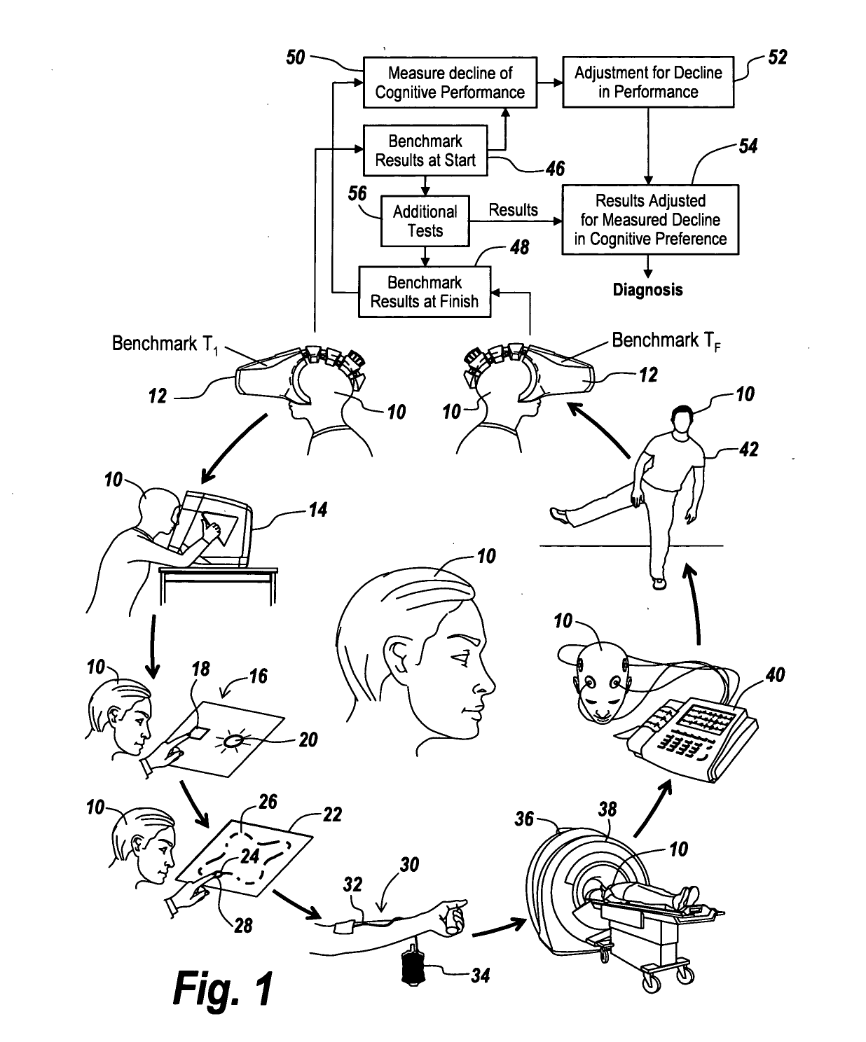

Referring now to FIG. 1, the administration of a multimodal testing regime for a patient or a test taking individual 10 includes a number of different types of tests or different modes of tests. Starting from the top left, a benchmark test 12 is selected in which on one embodiment, a device is mounted on an individual's head and eye tracking is utilized for cognitive performance testing. This type of head mounted device for eye tracking is described in U.S. patent application Ser. No. 13/506,840 by Matthew Stack filed May 18, 2012 and is incorporated herein by reference.

The second test to be administered is administered by a desktop unit 14 in which individual 10 peers into the device, with the individual's response to a moving dot or icon on an internal screen being a measure for the cognitive performance of the individual. This type of apparatus is shown in U.S. patent application Ser. No. 13/507,991 by Matthew Stack filed Aug. 10, 2012 and is also incorporated by reference.

Yet another type of cognitive performance test is a reaction time test here shown at 16 in which individual 10 is instructed to press an icon or button 18 upon the illumination of an icon 20, thus to test the individual's reaction time.

A manual cognitive performance test is illustrated at 22 in which individual 10 tries to track a moving icon 24 around a path 26 with his finger 28.

Another mode of testing is a biomarker test and this is illustrated at 30 in which blood is drawn at 32 and is collected at a receptacle 34 for testing of the individual's bodily fluids, namely blood, for ascertaining cognitive ability.

As illustrated at 36 an imaging test is illustrated in which individual 10 is positioned inside the head 38 of a CAT Scan or fMRI machine, and individual 10 is given mental tests to perform. Similar to EEG/MEG tests, the fMRI/CAT scan monitors how the brain responds to various audio stimuli or video image presentations on a screen. The audio or video presentation is typically a response or stimuli test where the test-taker is asked to react to physically by pressing a button or respond verbally to what is presented on a screen. Often the screen is inside these machines to allow the response tests to be given while the test-taker is inside the machine as it takes snapshots or images of the brain to show where the brain illuminates as the test-taker responds.

As illustrated at 40 EEG or MEG tests can also be performed on individual 10 to establish cognitive performance by measuring brain wave activity. In particular, the EEG/MEG tests monitor how the brain responds to various audio or video image presentations on a screen. It is generally paired with a reaction test where the test-taker is asked to react to physically by pressing a button or respond verbally to what is presented on a screen. EEG/MEG monitors brainwaves or electro- or magnetic signals through sensors placed on different parts of the head.

As illustrated at 42 a balance test can be administered to individual 10 in order to test for various cognitive abilities.

Thereafter, at the end of this battery of tests, the testing sequence returns to benchmark test 12 in which the cognitive performance of the individual is measured again.

The purpose of providing a benchmark test is to provide a test with the least cognitive load and the most accurate relevance to a particular cognitive function being measured. As can be seen, the first administration of the benchmark test, here indicated as benchmark T₁, records the results of the first benchmark test at 46, which corresponds to the start of the battery of tests.

The benchmark test T_{F} is utilized to establish the results at the finish of the testing cycle as illustrated at 48, with a measure of any change in cognitive performance between the start and the finish being provided by module 50. The measurement of the change in cognitive performance during the administration of the battery of tests is used at 52 to adjust the results of each of the tests for a detected change in performance. This is accomplished by an adjustment metric generated at 52 such that the results of the measured change in cognitive performance are used to adjust the results of each of the tests in the battery of tests, here illustrated at 54.

The tests that are adjusted are the additional tests 56 sandwiched in between the benchmark tests. These correspond to the tests administered between the initial benchmark test and the final benchmark test as illustrated at 56. Note all necessary associated with changes in cognitive performance as well as score adjustment may be performed on a special purpose processor or computer.

Having derived a number of different measurements of cognitive performance during the battery of tests, the results can be combined to accurately pinpoint or diagnose the cognitive condition of a test subject.

In one embodiment, the benchmark test is selected to be one in which there is little likelihood to be a difference in results for the cognitive function being tested between a test at the beginning of the battery of tests and a test at the end of the battery of tests. In other words, any change in the benchmark test results would indicate the change in the cognitive resource or ability only. This would mean that the benchmark test selected needs to have a low cognitive load and low difficulty for the individual being tested. It is also noted that the selected benchmark test is to have a high correlation to the particular cognitive function the individual is being tested for, be it memory, attention, visual spatial processing, motor skills, learning, anticipation, perception, chemo fog or for instance a particular cognitive performance disease such as Alzheimer's disease.

As will be seen, it is very important to be able to rate the particular tests that are to be administered during the battery of tests and as will be discussed hereinafter a matrix is formed with respect to test variables such as cognitive load, level of difficulty, strenuousness, meaning physical strenuousness, a learning affect, a range of expected outcomes, test outcome variability, test outcome granularity, test scoring error and degree of test reliability.

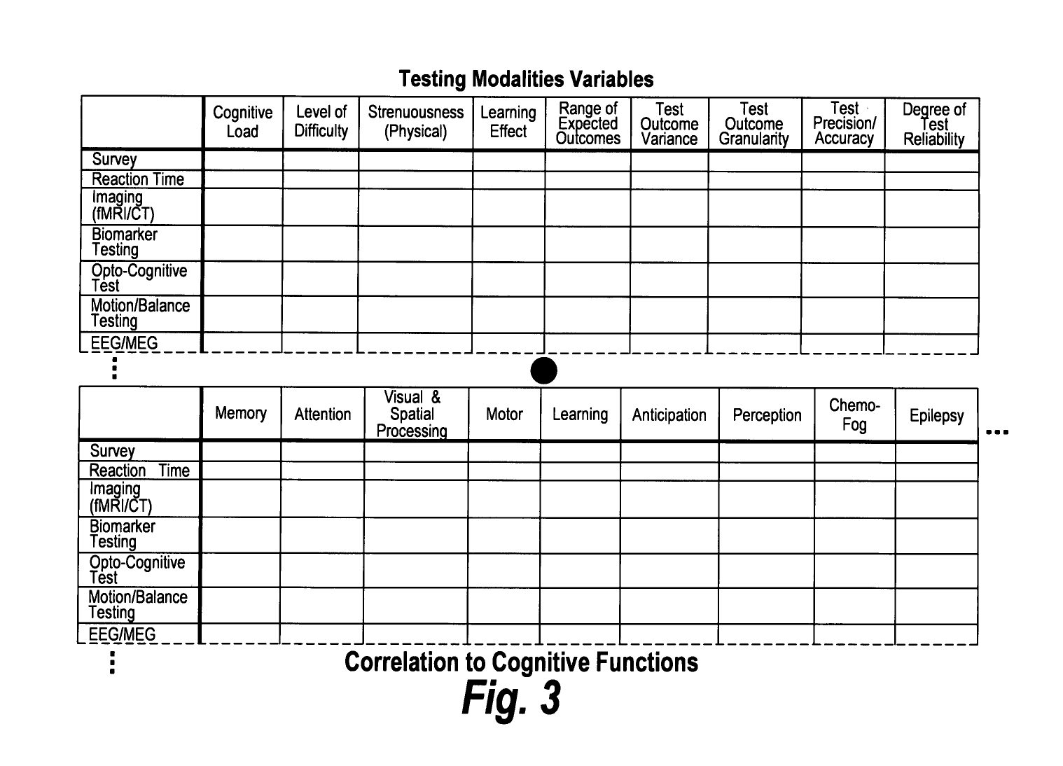

Having been able to populate the matrix shown in FIG. 3 hereinafter, it is possible to select not only which test should be the benchmark test but also to determine the minimum list of tests to be performed as well as the sequence or the testing order relative to the variables of FIG. 3.

Thus, for instance, it may be desirable to frontload the battery of tests with the least difficult tests so that any decline in cognitive performance will not affect test results. It is noted that tests such as fMRI, EEG and MEG tests are physically taxing on the individual and take considerable time for the tests to be administered. In one embodiment, these tests are moved to the end of the battery of tests so that whatever effect these tests have on cognitive ability will be lessened.

It is however important to note that whatever cognitive changes occur during the battery of tests may be utilized to correct for the results of the individual tests so that rather than simply assuming that there has been no cognitive change during the rather lengthy battery of tests, one can now adjust the scores of the various tests to be able to accurately diagnosis a patient's condition.

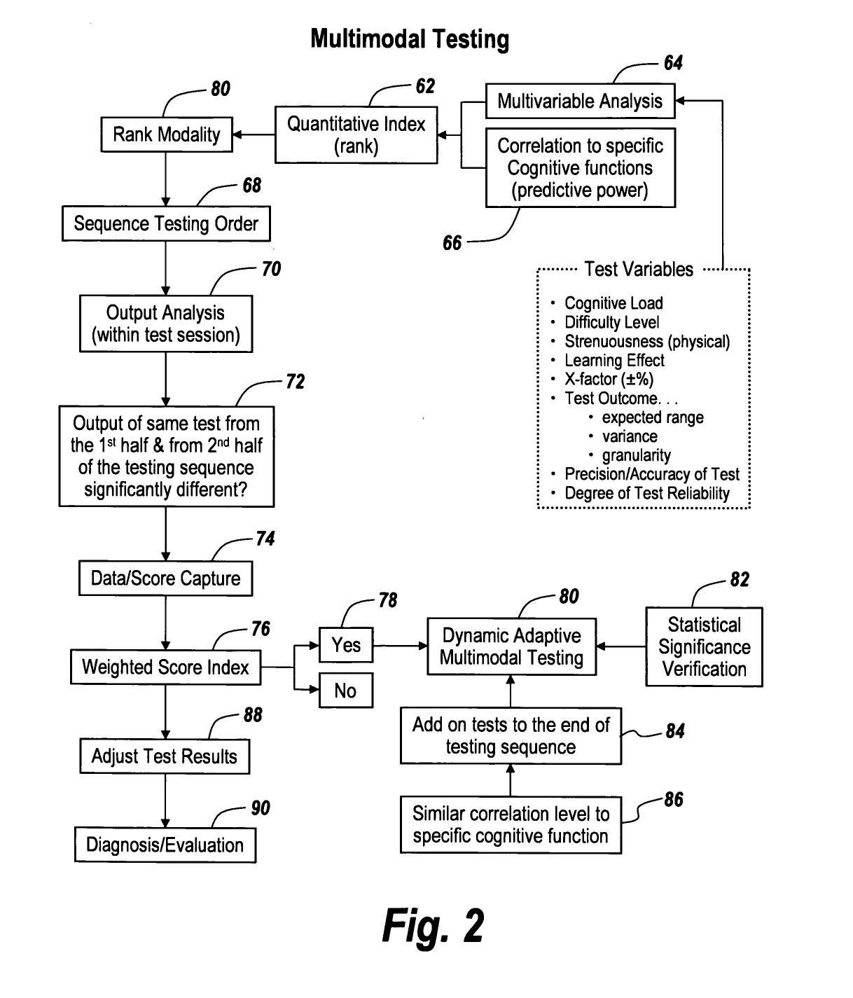

Referring now to FIG. 2 one of the most important things to do is to be able to rank a modality, here shown at 60, so as to be able to take into account all of the variables associated with a test and to provide a quantitative index or rank 62. This involves a multi-variable analysis 64 such as that to be described in connection with the FIG. 3 matrix. Also, the quantitative index or rank takes into account the specific cognitive functions to be tested. Correlation to specific cognitive functions relates to the predictive power of the particular test for the particular function tested for and this is illustrated at 66.

As discussed above and as to be discussed in detail below the test variables involve cognitive load, a difficulty level for taking the test, the strenuousness of the test meaning the physical stamina necessary to take the test, whatever learning effects impact the cognitive performance results and test outcome related variables. These include the expected range, the variance and the granularity of the particular test. There is also a test variable relating to testing error as well as the degree of test reliability.

More specifically, the testing modality variables are defined as follows:

### Cognitive Load

A measure of intensity that indicates how taxing an activity is to the brain.

### Level of Difficulty

A scale of how challenging a test is where one end of the scale is easier and the other end of the scale indicates more difficult. Level of difficulty is more specifically one location on that scale. The location on the scale is determined based on an index or function of how challenging it is for an average user and it is an index dependent on the person's ability and the test such as how many things will happen at the same time, how intense the focus needs to be to do what is required by the test, or how involved the test taker must be while performing the test.

### Strenuousness

### Physical

The amount of physical effort the test-taker needs to exert to take the test.

### Learning Effect

The degree to which the phenomenon of the test experience increases the score more than the attribute the test is measuring.

### Range of Expected Outcomes

The difference in score expected for a given patient's performance level that incorporates some variance in the test to measure the attribute, measurement error and the degree of variance the patient exhibits around the score. Represented as a percentage or a standard deviation of the score based on range of expected score previously scored for a population of individuals.

### Test Outcome Variance

The average of the squared differences from the mean of a standard deviation or distribution of the range of expected test scores previously scored for a population of individuals.

### Test Outcome Granularity

The accuracy or precision of the test in measuring the attribute the test is measuring.

### Test Scoring Error

Range of the output score that is dependent on the measurement error of the test that measures the objected attribute.

### Degree of Test Reliability

Ability of the test to return the same score the assuming the test taker doesn't change in the attribute the test is meant to measure.

All of these test variables go into the quantitative index rank of the tests so that when deciding what tests to include in the battery of tests one has a handy index for rating the benchmark test as well as the series of additional tests to be performed in the battery of tests. The quantitative index or rank as illustrated at 60 is used to determine the sequence testing order as illustrated at 68, with the testing sequence order being a reasoned order based on the various test variables as well as the correlation to a specific cognitive function one is testing for.

After deciding on the testing sequence, the results for each of the tests is outputted to an output analysis engine 70 which in the case of the benchmark test measures the results of the same test administered initially and at the end of the battery of tests. This output analysis is also applied for each test such that the results from the first half and the second half of each test are recorded to see if there is any significant difference between the two halves as illustrated at 72. Thereafter, there is a data/score capture at 74 and a weighted score index derived at 76.

If however there is a significant difference between the first half of a test and a second half of a test it may be important that the test results either be completely disregarded or the same test administered at a different time. Further, in the case of a failure of a given test, a different test that tests for the same cognitive function may be administered somewhere later in the battery of tests.

Thus, in one embodiment the subject invention relates to real time analysis of the tests as they are being administered to be able to delete results, modify test results or add additional tests for the same function that is being tested for.

The statistical reliability of the test is described in terms of the weighted score index 76 which if there is a significant statistical variation in the test scores as illustrated at 78 a dynamic adapted multimodal testing unit is invoked at 80 that based on statistical significance verification 82 adds additional tests 84 to the end of the testing sequence. As illustrated at 86, these additional test tests for a similar correlation level to a specific cognitive function.

The results of all of the individual tests in the battery of tests are adjusted at 88 to some normative value taking into account any cognitive change that has occurred during the administration of the battery of tests. Thereafter, as illustrated at 90, having adjusted each of the tests in the battery of tests for cognitive change a robust cognitive function diagnosis is now possible.

It will be appreciated that key to the robustness of the multimodal cognitive function diagnosis is the measurement of cognitive function change or cognitive resource change during the battery of tests. This change can either be a decline or enhancement in cognitive function or ability. As will be seen, one can apply a derived average change to the results of each of the tests in the battery such that evaluation is corrected for cognitive change, again a quantity not heretofore recognized as being important when administering a battery of tests.

As mentioned above, it is important to be able to classify each of the cognitive function testing modalities to be able to select which test should be used as a benchmark test and which minimum test set should be used for the diagnosis of a patient without undo testing. As can be seen from FIG. 3, on the left hand side, are the types of test modalities that could be utilized in the diagnosis of the patient. As listed, the tests include a survey, a reaction time test, imaging tests such as fMRI and CT scans, biomarker testing, opto-cognitive testing such as smooth pursuit testing, motion and balance testing and EEG/EMG types of testing. Each of these testing modalities has associated with it a range of variables.

As can be seen by this matrix for each of these types of tests the following variables are useful in describing the robustness and functionally of the tests. These variables are defined above.

First is the cognitive load, second is the level of difficulty, third is the strenuousness meaning the physical strenuousness, fourth is the learning affect, fifth is the range of expected outcomes, sixth is the test outcome variability, seventh is the test outcome granularity, eighth is test scoring error and ninth is the degree of test reliability.

Having been able to populate a matrix of testing modality variables there is one further cross correlation that must be made for each of the tests and this cross-correlation is to the particular cognitive function or functions that the test is adapted to measure. If one can cross-correlate the cognitive function matrix with the testing modality variable matrix in a cross-correlation between the two matrices one can develop the quantitative index or rank for the modality.

As will be seen with respect to the correlation to cognitive function, the type of cognitive functions that may be tested for are memory, attention, visual spatial processing, motor skills, learning, anticipation, perception, chemo fog and a particular disease such as epilepsy. It will be noted that the modalities are the same modalities as noted at the top of FIG. 3 so that the correlation of each of the modalities to a particular cognitive function may be ascertained.

Note that all testing, cognitive change measurements, modulation of test variable metrices, test score adjustment, and test selection may be performed on a specialized processor.

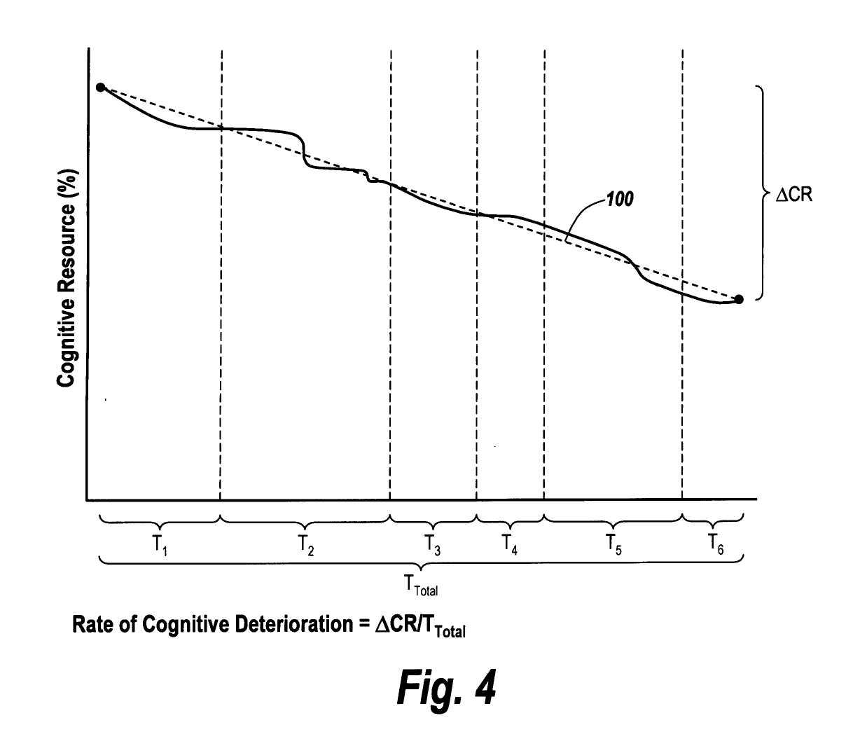

Referring now to FIG. 4, tests T₁-T₆ have the cognitive resource percent graphed against the time it takes to administer the particular test. It will be seen that test T₁ corresponds to the benchmark test which is administered at the beginning and the end of the battery of tests. T₂ shows an average cognitive resource decline, as do tests T₃-T₆ such that there is a continuing cognitive decline as would be expected during the administration of the battery of tests. The average decline is illustrated by dotted line 100 and corresponds to a change ΔCR in cognitive resource between the administration of the first test and administration of the final test.

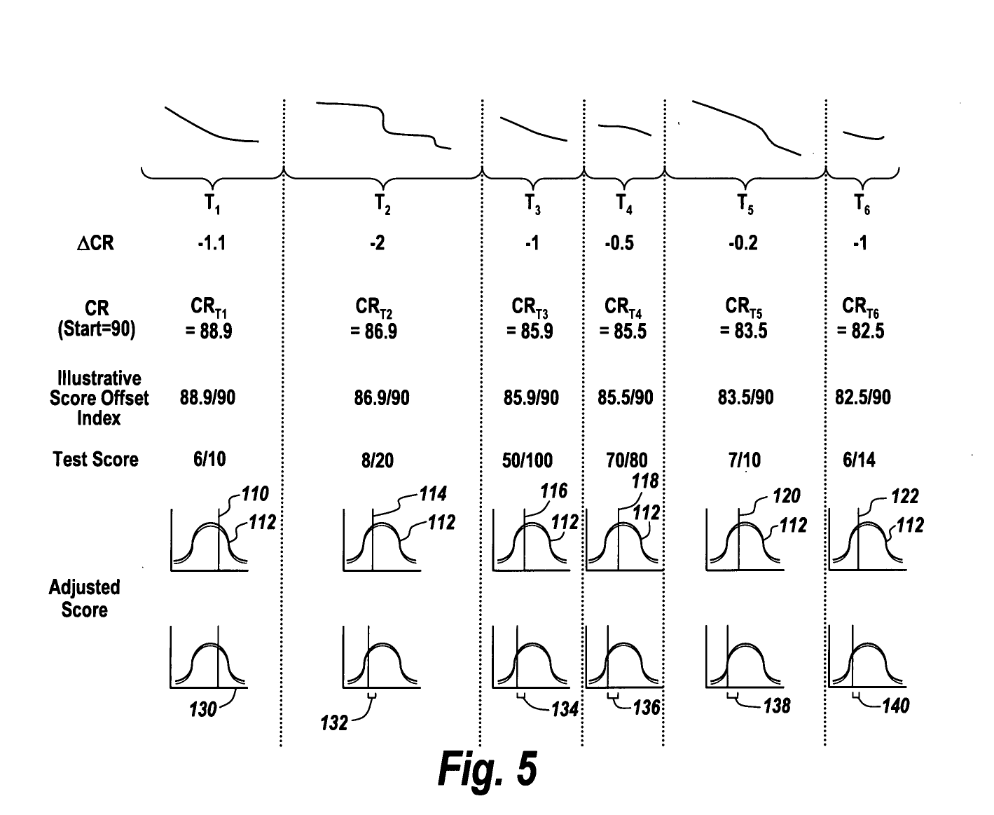

Referring now to FIG. 5, what is shown is an example of a decrease in cognitive resource for Tests T₁-T₆ in terms of a ΔCR, which is the percentage decrease in the cognitive function measured. As can be seen the change in cognitive resource for T₁ is −1.1, T₂ −2, T₃ −1, T₄ −0.5, T₅ −0.2 and T₆ −1. These cognitive function decreases are normalized to a start number 90 as illustrated. As can be seen, the illustrative score offset index is based as a percentage with 90 in the denominator, with the test scores ratios in the illustrated embodiment being 6/10, 8/10, 50/100, 70/80, 7/10 and 6/14. Assuming that each of the scores for each of the modalities is representable by a normal distribution, then as illustrated at 110, the intersection of the test result with normal distribution 112 is noted for test T₁. The same is true for Test T₂ in which the intersection 114 is with respect to normal distribution 112, whereas Test T₃ has its intersection 116 shown as the corresponding intersection with normal distribution 112. Test T₄ has its intersection 118 with normal distribution 112, with Test T₅ having its intersection 120 with normal distribution 112 and with T₆ having its intersection 122 with normal distribution 112 as illustrated. Just below each of the intersections of each of these normal distributions is an indication of a correction or shift, which takes into account the measured cognitive resource decline. Note, while there is no cognitive resource decline for Test T₁, as illustrated at 130 there is a shift 132 on the normal distribution for Test T₂, a shift 134 on the normal distribution for Test T₃, a shift 136 for Test T₄, a shift 138 for Test T₅ and a shift 140 for Test T₆. What can be seen is that all of the tests are corrected for the measured decline in cognitive performance during the battery of tests, with the corrected intersections providing normalized score numbers that may be utilized together to obtain an accurate picture of a particular cognitive function of the patient.

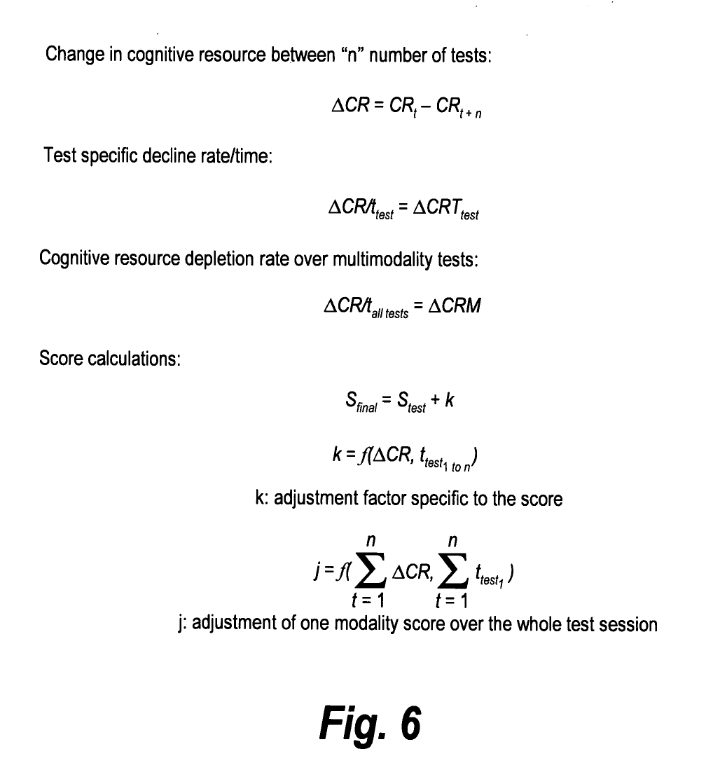

Referring to FIG. 6, the formula for the adjustment of modality score over the whole test session is derived by denoting that the change ΔCR between “n” number of tests is the cognitive resource for the first test minus the cognitive resource for T plus n.

The test specific decline rate/time is ΔCR/Tₜₑₛₜ or Δ=ΔCRTₜₑₛₜ.

The cognitive resource depletion rate over the battery of tests ΔCR/T for all of the tests is equal to ΔCRM, which is defined as the rate of cognitive resource depletion over multimodality tests.

As to the score calculations the S_{final} score is equal to the Sₜₑₛₜ score plus k, where k is a function of ΔCR, t_{test1 to n}. Here k is the adjustment factor specific to the score.

As can be seen from the final expression of FIG. 6 the adjustment j of one modality score over the whole test section is a function of the summation off from t=1 to n for ΔCR, the summation from t=1 to n for tₜₑₛₜ₁.

Thus, as can be seen, the adjustment is sensitive to the various declines during the battery of tests and is applicable to provide an adjustment to each of the test scores so that when taken as a whole the test scores available from the battery of tests can accurately reflect the cognitive function of the test individual for a particular one or more cognitive functions.

### Test Sequencing

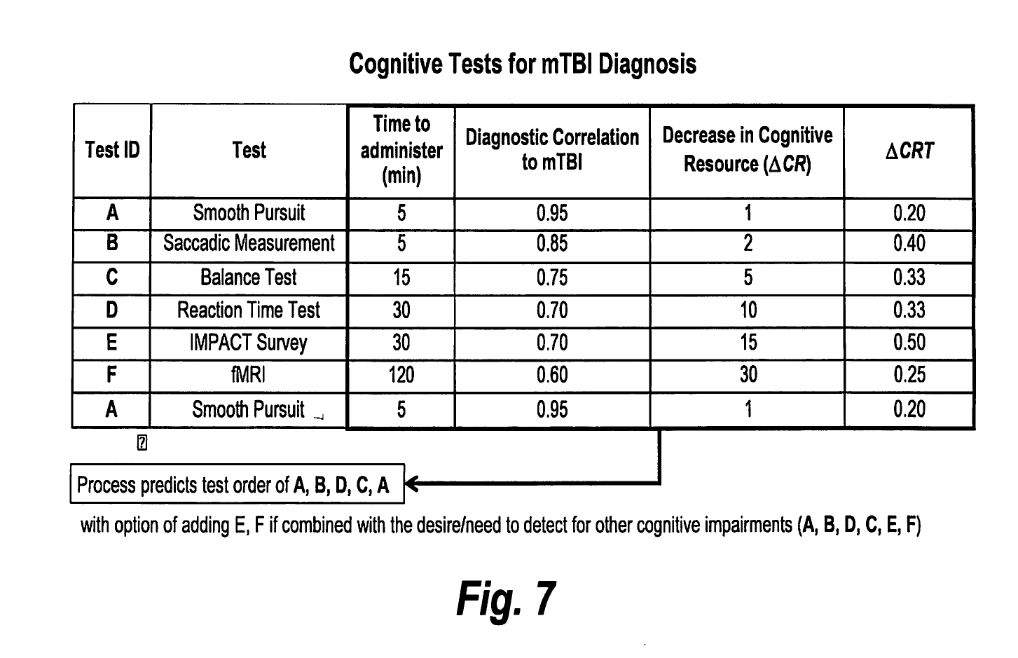

What is now described is an example of the ordering of tests designed to detect mTBI or mild traumatic brain injury. Referring now to FIG. 7, in order to obtain an order or sequence of the tests to be administered to test for mild traumatic brain injury, there are four test variables to take into consideration. These variables are the time to administer the test, a diagnostic correlation to mTBI, the decrease in cognitive resource, ΔCR and the rate of decrease in the cognitive resource, ΔCRT.

The tests to be considered in the diagnosis of mTBI are Smooth Pursuit, Test A, Saccadic Measuring, Test B, Balance Test, Test C, Reaction Time Test, Test D, IMPACT Survey, Test E, and fMRI, Test F.

Note the smooth pursuit test, Test A, repeated at the beginning and end of the battery of tests, is selected as the benchmark test because it has a high correlation to mTBI and a low decrease in cognitive resource (ΔCR), which implies the test has a low cognitive load and level of difficulty.

Having determined the benchmark test, Test A, it is then important to be able to establish the minimum number of additional tests to test for mTBI and to establish the test order. Once having ascertained a high correlation to a particular disease or mental state, the goal is to take the high cognitive load relevant tests first so that they can be done while the patient is not tired out by the testing procedure.

Thus, the first and most important variable to ordering the tests is the correlation to a particular disease or mental state. The higher the correlation, the more important to put the particular test first, explaining why Test A is chosen as the benchmark test and B is chosen as the second test. Then if the correlations are similar, the next factor to consider is the cognitive resource decrease (OCR) that would signify how high of a cognitive load and how high the difficulty of the test is for the test-taker. In other words, if the correlations are similar, then one would want to put the test with the higher cognitive resource decrease as the first additional test. Thus in the illustrated example one would have the order of D, C next in line, as the test C and D have similar correlations and the same rate of cognitive resource decrease (ΔCR), but D has a significantly higher cognitive resource decrease (ΔCR) than C.

In addition, one has to take variables ΔCRT, which is the rate at which the cognitive resource decreases, and the time it takes to administer the test into account. This is why Test E and F are deemed optional additional tests because Test E has a fairly low correlation to mTBI and a very high rate of cognitive resource decrease (ΔCRT) and Test F has a very low correlation to mTBI and the time to administer the test is very long. However, both of these tests have correlation to other cognitive functions as well as mTBI, which is why they would be added if there were other cognitive impairments in addition to mTBI that were in question for the test-taker.

It will be noted that the table in FIG. 7 contains data useful in establishing test sequencing. Note the table is of tests that are currently given to patients today to diagnose mTBI, and is populated with data from previous studies and test-takers.

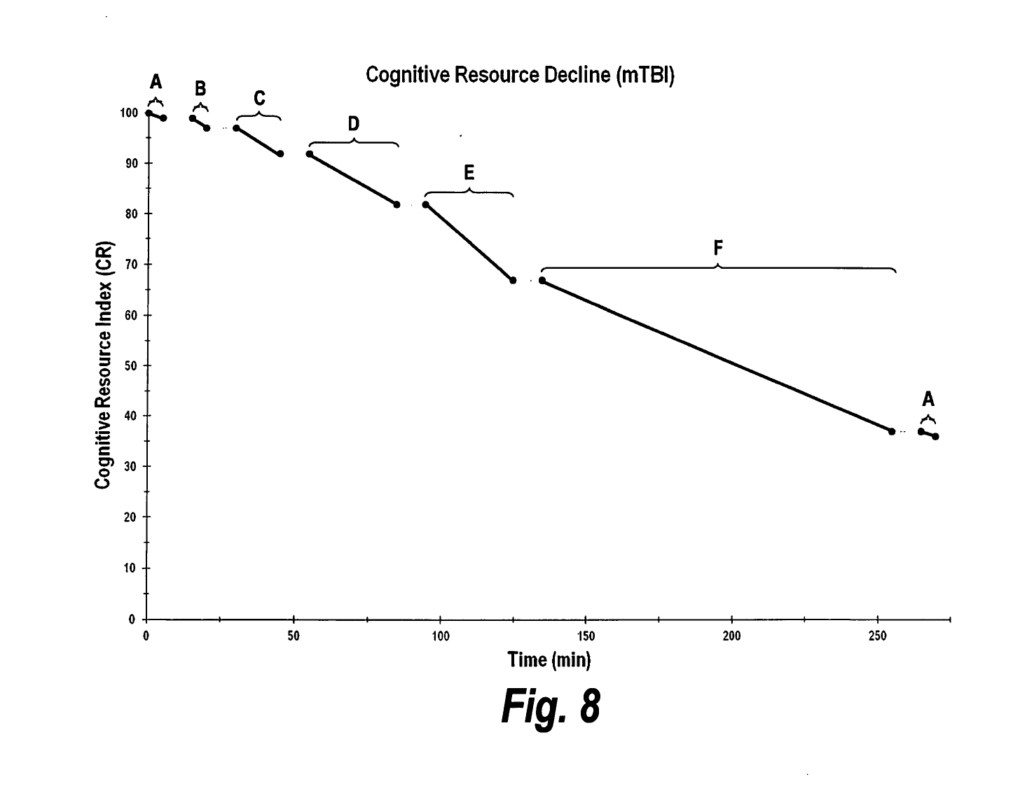

FIG. 8 is a graphic representation of the table in FIG. 7, illustrating the change in cognitive resource over time when the battery of tests are administered with 10 min intermission/break time for the test-taker.

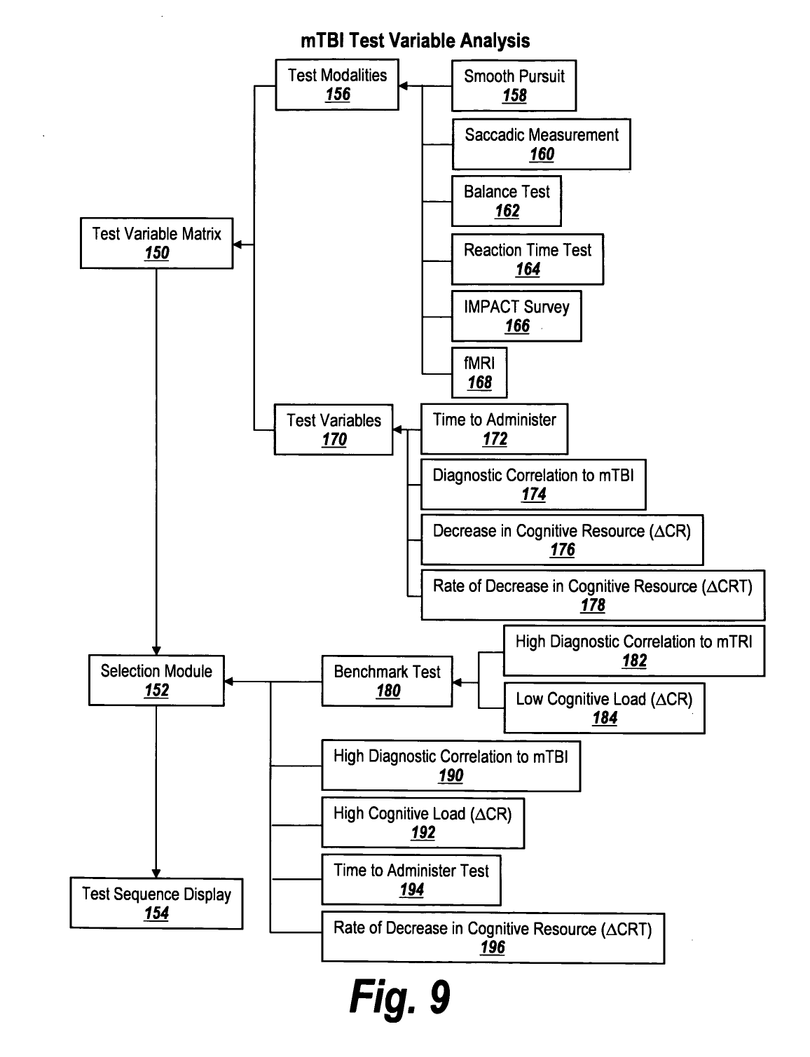

Referring now to FIG. 9, apparatus in the form of a system is described for presenting a test administrator a listing and ordering of tests to be performed when administering a battery of tests targeting a particular disease or cognitive function of a patient.

The system involves populating a test variable matrix 150, the output of which is coupled to a selection module 152 that is in turn coupled to a display 154 of the tests to be administered and the sequence of the tests as illustrated.

In order to provide for the selection of a benchmark test as well as additional tests, a number of tests that are relevant to the disease or cognitive state are identified.

For instance, for an mTBI test, testing modalities 156, such as smooth pursuit 158, a saccadic measurement 160, a balance test 162, a reaction test 164, an IMPACT survey 166 or an fMRI test 168 are identified as being useful in detecting mild traumatic brain injury.

Having identified the test modalities, the system loads into test variable matrix 150 the associated test variables 170. In the illustrative embodiment these include the time to administer a test 172, the diagnostic correlation to mTBI 174, the decrease in cognitive resource, for instance ΔCR 176, and the rate of decrease of cognitive resource ΔCRT 178. These variables are those associated with each of the test modalities 156 and are used to populate matrix 150 such that the matrix that is created corresponds for instance to the matrix of FIG. 7.

The values in matrix 150 are supplied to selection module 152 in the first instance for selecting a benchmark test 180 which is selected due to a high diagnostic correlation to mBTI as illustrated at 182 as well as a low cognitive load, ΔCR 184. The selection of the benchmark test is then displayed at 154.

As will be appreciated the benchmark test is selected by module 152 from the tests represented by test modality 156, with the particular benchmark test being selected utilizing the variables from matrix 150.

Thereafter selection module 152 is utilized to select additional tests from modality 156, whose variables are available from matrix 150.

To select and order the additional tests, matrix 150 provides data as to high diagnostic correlation to mTBI as illustrated at 190, high cognitive load ΔCR as illustrated at 192, the time to administer the test illustrated at 194 and the rate of decrease of cognitive resource ΔCRT 196. As stated above the goal for the additional tests is to first select one of a high diagnostic correlation followed by the ones associated with a high cognitive load. The selection and ordering may be done automatically based on the population of matrix 150 taking into account factors 190-196.

In general, test modalities of 156 can include all of the test modalities of FIG. 3, namely survey, reaction time test, imaging, biomarker tests, octo-cognitive tests, motion/balance tests, and EEG/MEG tests, as well as others.

What is thus shown in FIG. 9 is apparatus in the form of a system that uses a specialized processor for populating a test variable matrix and that then uses the information in the matrix to automatically select both the benchmark test and additional tests, with the test selections and ordering presented to the test administrator on a display.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. A method for performing a battery of multimodal cognitive performance tests in which any cognitive change in a patient during the administration of the battery of tests is detected.

2. The method of claim 1, and further including adjusting test scores for tests in the battery of tests in accordance with detected cognitive change.

3. A method for performing a battery of multimodal cognitive performance tests in which a benchmark test is identified and administered at the beginning and end of the battery of tests and any cognitive resource change between the administrations of said benchmark test is measured.

4. The method of claim 3, and further including adjusting test scores for tests in the battery of tests in accordance with measured cognitive resource change.

5. A method for administering a multimodal battery of cognitive performance tests in which a benchmark test is selected as one having a high diagnostic correlation to a predetermined cognitive function and a low cognitive load.

6. A method for administering a multimodal battery of cognitive performance tests in which the sequence of administering cognitive performance tests in the battery of multimodal cognitive performance tests is determined by ranking the tests in the battery of tests and the sequence of tests in the battery of tests is arranged in accordance with rank.

7. A method for performing a battery of multimodal cognitive performance tests comprising the step of identifying a number of additional cognitive performance tests to be sandwiched in between the administrations of a benchmark test.

8. The method of claim 7, and further including the steps of providing a test sequence for the additional cognitive performance test that provides that the test having a high diagnostic correlation to a predetermined cognitive function and a high cognitive load is first in the sequence of additional tests.

9. A method for performing a battery of multimodal cognitive performance tests by ordering the administration of the tests such that the tests having the greatest rate of decrease in cognitive resource are placed ahead of other tests having less of a rate of decrease in cognitive resource.

10. A method of performing a multimodal battery of cognitive performance tests comprising the steps of:
identifying a benchmark test for a predetermined cognitive function of a patient;
administering the benchmark test at the beginning and at the end of the battery of tests; and,
detecting any cognitive change in the patient during the administration of the battery of tests.

11. The method of claim 10, and further including the steps of administering additional cognitive performance tests between the administrations of the benchmark test, obtaining the results of the additional cognitive performance tests in terms of test scores and adjusting the test scores associated with the additional tests to take into account any detected change in cognitive performance.

12. The method of claim 11, wherein all tests scores are normalized.

13. The method of claim 12, wherein the adjustment of the test scores associated with the additional tests are adjusted from their normalized values in accordance with a detected change in cognitive performance.

14. The method of claim 13, and further including the steps of diagnosing the patient for the particular cognitive function tested for utilizing the adjusted scores as well as the score associated with the benchmark test.

15. The method of claim 11, wherein for each of the additional tests a test score is derived from a first half of the additional test and a second half of the additional test.

16. The method of claim 15, and further including determining the statistical significance of the differences in the test scores between the first half and the second half.

17. The method of claim 16, wherein if the difference in test scores between the first half and the second half is statistically significant then either ignoring the results of the additional test or adding on an additional test to the end of the battery of tests, the additional test being added having a similar correlation level to the specific cognitive function tested for.

18. The method of claim 6, and further including the step of selecting which test in a series of multimodal tests is to be added to the battery of tests.

19. The method of claim 18, wherein each of the test modalities has associated with it a number of test variables, with test selection being based on test variables.

20. The method of claim 19, wherein the test variables include cognitive load.

21. The method of claim 19, wherein the test variables include difficulty level.

22. The method of claim 19, wherein the test variables include physical strenuous of taking a test.

23. The method of claim 19, wherein the test variables include learning effect.

24. The method of claim 19, wherein the test variables include test outcomes.

25. The method of claim 24, wherein the test outcomes include one of expected range and variance.

26. The method of claim 19, wherein the test variables include precision or accuracy of the test.

27. The method of claim 19, wherein the test variables include degree of test reliability.

28. The method of claim 6, wherein the rank of the modality includes predictive power correlation to a predetermined cognitive function.

29. The method of claim 6, wherein the testing order of the sequence of tests in the battery of tests is determined by the rank of the test modality.

30. The method of claim 29, wherein the rank of the test modality is determined from a matrix of test modality variables versus test modality type.

31. The method of claim 30, wherein the test modality type includes one of a survey type, a reaction time type, an imaging type, a biomarker testing type, opto-cognitive testing type, a motion testing type, a balance testing type, and an EEG/MEG testing type.

32. The method of claim 31, wherein the imaging type includes one of fMRI and CT scanning.

33. The method of claim 30, wherein the testing modality variable matrix is cross correlated with a matrix defining the correlation of a modality to a predetermined cognitive function to derive rank.

34. The method of claim 33, wherein the predetermined cognitive function includes one of memory, attention, visual and special processing, motor function, learning, anticipation, perception, chemo-fog, and a particular cognitive function disease.

35. A method of determining a benchmark test used in the administration of a multimodal battery of cognitive performance tests at the beginning and end of the battery of tests comprising the steps of:
identifying for a number of cognitive performance tests a test having a high diagnostic correlation to a predetermined cognitive function and that also has a low cognitive load, such that the benchmark test is highly relevant and such that the results from administering the benchmark test at the beginning of the battery of tests and at the end of the battery of tests results in a low cognitive function change over the testing period associated with the battery of tests.

36. The method of claim 35, wherein additional tests are selected to be included in the battery of tests based on a ranking related to a high diagnostic correlation to the predetermined cognitive function and a high cognitive load.

37. The method of claim 35, wherein additional tests are selected based on a ranking related to a high diagnostic correlation of the test to the predetermined cognitive function and a high cognitive load associated with taking the additional test.

38. The method of claim 37, and further including as a factor in the selection of the additional test the time to administer a test and the rate of decrease in cognitive resource associated with the additional test.

39. The method of claim 38, wherein the step of selecting an additional test selects for an additional test that test having a high diagnostic correlation to the predetermined cognitive function and a high cognitive load.

40. The method of claim 38, wherein in the selection of the additional test, those tests having considerable time to administer the test are administered at the end of the battery of tests.

41. The method of claim 35, and further including the step of ascertaining the rate of decrease in cognitive resource associated with a test and placing that test having the greatest rate of decrease in cognitive resource ahead of other tests having less of a rate of decrease in cognitive resource.

42. In a multimodal test regime involving the administration of a battery of tests, a method of selecting for inclusion in the battery of tests test modalities including one of smooth pursuit testing, saccadic measurement, balance testing, reaction time testing, impact surveys and fMRI/CT scan testing.

43. The method of claim 42, wherein the test modalities are ranked in accordance with the type of test and test variables.

44. The method of claim 43, wherein the test variables include one of time to administer a test, diagnostic correlation to a particular cognitive function, decrease in cognitive resource and rate of decrease of cognitive resource, the test variables and modalities being included in a test variable matrix that is used in the selection of a benchmark test to be administered at the beginning and end of a battery of tests and additional tests to be sandwiched between the administrations of the benchmark tests.

45. The method of claim 44, wherein test selection is displayed as a sequence listing of the tests in the battery of tests.

46. Apparatus for use in performing a battery of multimodal cognitive performance tests comprising:
a processor for detecting any cognitive change in a patient during the administration of the battery of tests.

47. The apparatus of claim 46, wherein said processor adjusts test scores for tests in the battery of tests in accordance with detected cognitive change.

48. The apparatus of claim 46, wherein said processor is programmed to identify a benchmark test, with said benchmark test being administered at the beginning and at the end of said battery of tests.

49. The apparatus of claim 48, wherein said processor identifies additional cognitive performance tests to be administered, receives the tests scores associated with said additional cognitive performance tests and adjusts the test scores associated with said additional cognitive performance tests to take into account any detected change in cognitive performance of a patient.

50. The apparatus of claim 49, wherein said processor normalizes all test scores.

51. The apparatus of claim 50, wherein said processor adjusts the test scores associated with said additional tests from their normalized values in accordance with said detected change in cognitive performance.

52. Apparatus for determining cognitive resource change induced while performing a multimodal battery of cognitive performance tests, comprising:
a process for identifying and administering a benchmark test at the beginning and end of said battery of tests and for measuring any cognitive resonance change between the administrations of said benchmark test.

53. Apparatus for use in the administration of a multi-modal battery of cognitive performance tests, comprising:
a processor for selecting a benchmark test as one having a high diagnostic correlation to a predetermined cognitive function and low cognitive load.

54. Apparatus for determining the sequence of administering cognitive performance tests in a battery of multi-modal cognitive performance tests, comprising:
a processor for ranking said tests in the battery of tests and arranging the sequence of tests in the battery of tests in accordance with said ranking.

55. The apparatus of claim 54, wherein said battery of tests includes a benchmark test administered at the beginning and the end of the battery of tests.

56. The apparatus of claim 55, wherein said benchmark test is selected as one having a high diagnostic correlation to a predetermined cognitive function and a low cognitive load.

57. The apparatus of claim 56, wherein said processor is used to identify a number of additional cognitive performance tests to be sandwiched in between the administrations of said benchmark test.

58. The apparatus of claim 57, wherein said processor automatically ranks said additional tests and provides a sequence such that a test having a high diagnostic correlation to a predetermined cognitive function and a high cognitive load is placed ahead of others not having the high correlation and high cognitive load.

59. The apparatus of claim 58, wherein said processor orders said additional tests to place at the head of said battery of additional tests those having the greatest rate of decrease in cognitive resource ahead of other additional tests having less of a rate of decrease in cognitive resource.

60. The apparatus of claim 46, wherein said processor performs the ranking of said cognitive performance tests based on a test variable matrix cross correlated with a matrix defining the correlation of a cognitive performance test to a predetermined cognitive function to be measured.

61. The apparatus of claim 60, wherein said correlation includes the predictive value of said cognitive performance test.

62. Apparatus for use in performing a multimodal battery of cognitive performance tests, comprising:
a processor for ordering the sequence of tests in said battery of tests by placing a test having a high rate of decrease in cognitive resource as a result of taking said battery of tests ahead of other tests in said battery of tests.
